(19) United States
(12) Patent Application Publication
(10) Pub. No.: US 2005/0251938 A1
(43) Pub. Date: Nov. 17, 2005

(54) Snake plunger

(76) Inventors: William Richard Hofer SR., Marysville, CA (US); Sharon Lee Hofer, Marysville, CA (US)

Correspondence Address: William R. Hofer, SR., 33 Montana Dr., Marysville, CA, 95901, US

(21) Appl. No.: 10/884,259

(22) Filed: Jul. 2, 2004

Related U.S. Application Data
(60) Provisional application No. 60/571,808, filed on May 17, 2004.

(51) Int. Cl. B08B 9/04

(52) U.S. Cl. 15/104.33; 4/255.01

(57) ABSTRACT

An apparatus for unclogging a toilet with the sliding mechanism allowing for easier operation. The sliding mechanism easily allows movement of the snake within the handle. The sliding handle is in a locked position when the snake is not in use. The rubber air tube, when plunging, does not allow water to enter. There is a reducer connecting the plunger to the stationary handle. There is a hollow nipple inside the reducer which connects to the lower end of the rubber tube. The snake goes through the nipple and up the hollow tube to the sliding mechanism. The top end of the rubber tube is connected to the sliding mechanism. The top end of the snake is threaded through the sliding mechanism, and there is a locking device on the top of the sliding mechanism connected to the snake. This is helpful for new “low flow” toilets.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of plumbing, pipes and blockages, and more specifically to the field of blocked, clogged toilets.

The clogging of toilets has been a long time problem, but has become even more of a problem since the use of low-flow toilets which has become mandatory in parts of the United States and will probably be used throughout the United States before long, due to water conservation. This creates a problem with toilets clogging and over flowing due to insufficient water flow. At this time an implement is needed to alleviate the expensive problem of purchasing different types of tools, now available, when one tool would be all that is necessary to the unclogging of toilets. This invention solves this problem. First there was the plain plungers that were designed for suction, there was a handle with a rubber suction device on the end, therefore breaking the clog lose. This was seldom successful. Then the snake. a twisted wire, which was long and cumbersome. Then they tried to improve with a shorter snake that you twisted with a handle, and a rubber grip. Then came a pleated plunger with a shorter snake, which is removable, coupled to a handle. Most recently there was a short thin plastic. bellowed plunger with a snake embodied into the handle.

The plain plunger causes a lot of splashing and spillage, and most often was unsuccessful. Due to the clogs being deep in the toilet, or drains a person would have to buy a separate snake, which was springy, long and cumbersome and difficult to use. The shorter snake that you had to twist with a handle sometimes broke pipes and or toilets. The short, light plastic, bellowed plunger has a snake embodied within, but the problem with this one is that the snake doesn't go down far enough, in most cases, to unclog the deeper blockage.

The difference between our toilet snake plunger and the other plungers is that it has a unique sliding mechanism that propels and retracts the elongated snake easily into the toilet and through the curves and bends without the operator having to touch the snake itself making it more sanitary, and efficient Furthermore, you do not have to change snakes for different lengths. While plunging with this snake plunger, the sliding handle is in a locked position. The air tube being in the stretched position helps to keep waste water out. When snake is needed, you simply have to remove the sliding handle from the locked position, which releases the sliding mechanism, which in turn thrusts the snake downward, then retracts it when finished. After a person is through using the snake plunger, they would retract the snake and put the sliding handle back into the locked position which stretches the air tube back out and eliminates any potential water build up.

### BRIEF SUMMARY OF THE INVENTION

The primary object of the invention is to provide a better plunger with a snake built into one tool.

Another object of the invention is to eliminate splashing and reduce overflow waste water.

Another object of the invention is to decrease the cost to the consumer, having it all in one tool.

A further object of the invention is there is a sliding mechanism inside the stationary handle.

Yet another object of the invention is the plastic sliding handle propels the snake downward into the drain.

Still yet another object of the invention is the length of the stationary handle provides room for a longer snake.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for unclogging a toilet comprising of the sliding mechanism containing steel ball bearings allowing for easier operation. The unique sliding mechanism easily allows movement of the snake within the handle, no other plunger has this sliding mechanism, which makes this plunger unique. The sliding handle is in a locked position when the snake is not in use. The rubber air tube, when plunging, allows very little, if any, water to enter. There is a reducer connecting the plunger to the stationary handle. There is also a flat washer connected to a smaller reducer (also referred to as lower ribbed connection for air tube nipple) which prevents the reducer from sliding up the stationary handle, thus being able to stretch out and hold in place the air tube, which is held in place by the stationary handle. The snake goes through the smaller reducer and up the hollow tube to the sliding mechanism. The top end of the rubber tube is connected to the sliding mechanism. The top end of the snake is threaded through the sliding mechanism, and there is a locking device on the top of the stationary handle connected to the sliding.handle.

When the sliding mechanism is in the locked position the invention is used as a plunger only. When plunging doesn't unclog the blockage, the user removes the sliding handle from the locked position which allows the sliding handle to drive the snake into and through the toilet thus freeing the blockage.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1A is a cross section of the top half of the invention.

FIG. 2A is a cross section of the bottom half of the invention.

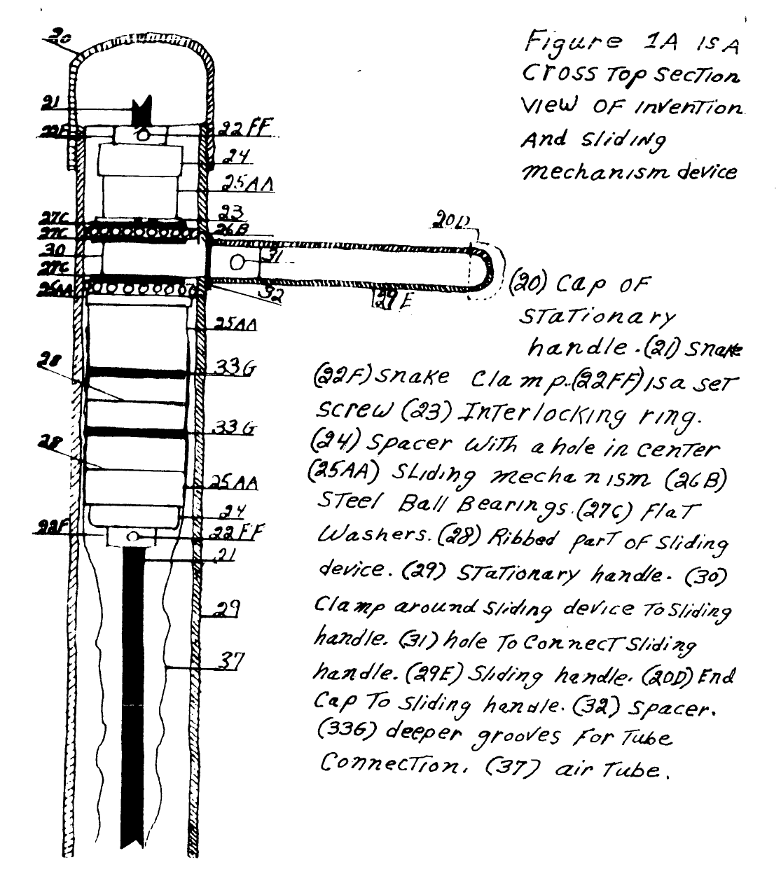

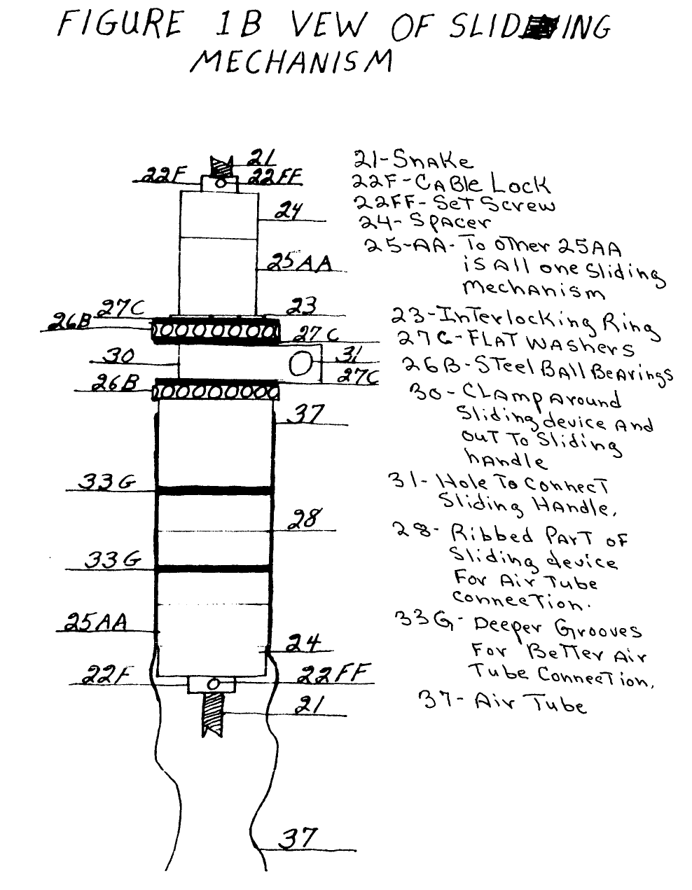

FIG. 1B is a break down of the sliding mechanism of the invention.

FIG. 1C is a plain view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Turing first to drawing FIG. 1A, you will notice a cross section view of the top portion of the stationary handle #29, of the apparatus, On the same drawing, there is also a sliding handle #29E, in the locked position. In accordance with an important function of the invention, built inside the handle are the sliding mechanism #25AA, and the snake #21, are also shown. You will notice the air tube #37, that is connected to the sliding mechanism #25AA. The same drawing shows the snake #21 threaded within the sliding device #25AA. #20 is a cap of stationary handle. #21 is a snake. #22F is a snake clamp. #22FF is the set screw. #23 is a interlocking ring. #24 is a spacer with hole in center. #25AA is the sliding mechanism. #26B are steel ball bearings. #27C are flat washers. #28 is ribbed part of sliding device. #29 is a staionary handle. #30 is a clamp around sliding mechanism to sliding handle. #31 is a hole to connect sliding handle. #29E is the sliding handle. #20 is the end cap to sliding handle. #32 is a spacer. #33G is deeper grooves for tube connection. #37 is the air tube.

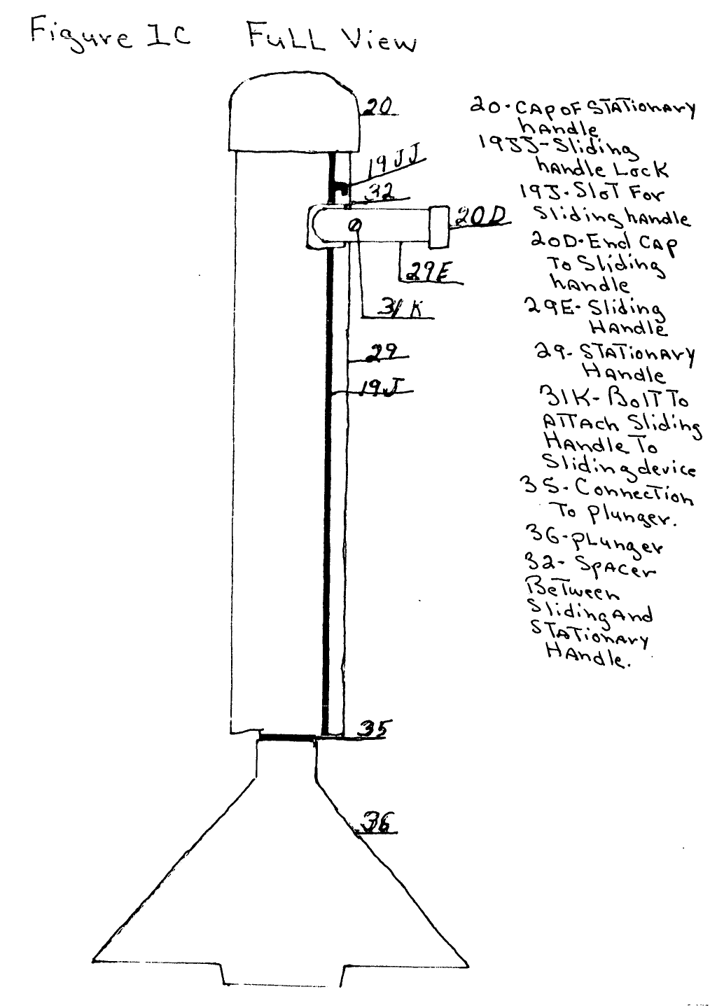

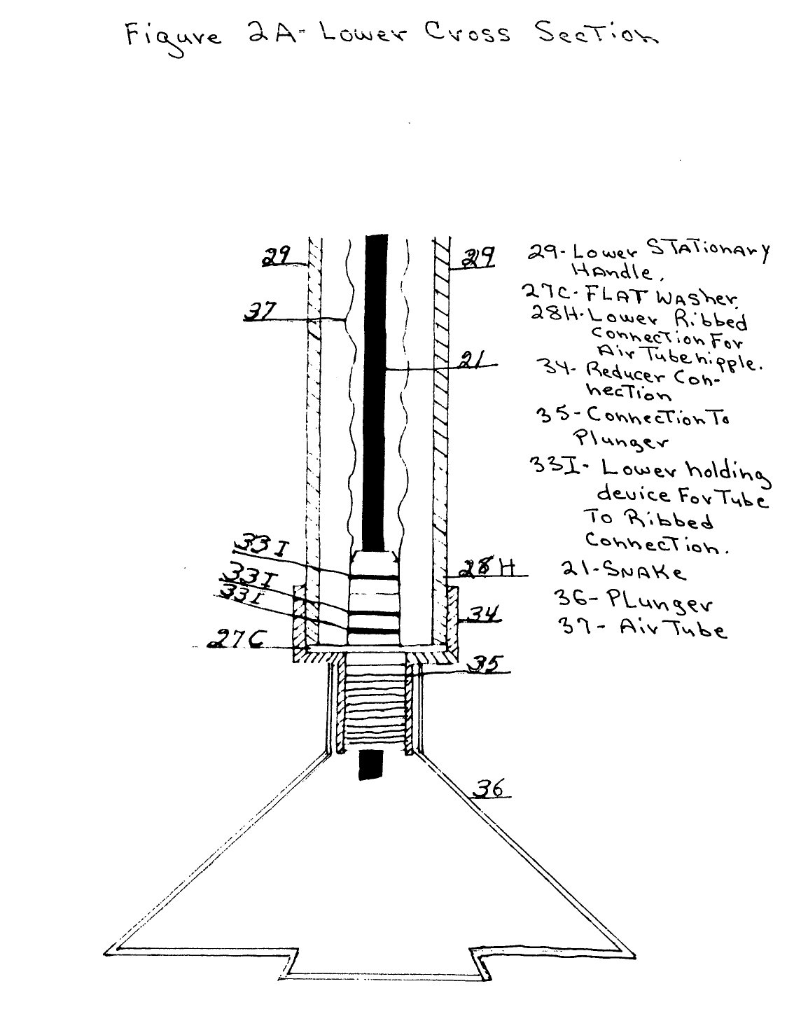

Turing to drawing FIG. 2A, you will notice the cross section of the lower portion of the #29, the lower stationary handle. invention. This makes it clearer, showing both top and bottom sections. It shows the bottom portion of most of the features already mentioned in FIG. 1A, which are the stationary handle #29, the air tube #37, and the snake #21. This drawing also contains the lower ribbed nipple connection #28H, for air tube attached to the reducer #34, which is connected to the rubber power plunger #36. #35 is a reducer connected to the plunger. #331 is a lower holding device for tube to lower connection.

It is to be noted that in FIG. 1B an important feature of this invention is an enlarged view of the sliding mechanism #25AA, showing all the detailed parts. Starting with #21 which is the snake, #22F is a cable lock. #22FF is a set screw. #24 is a spacer. #25AA to other #24AA is all one sliding mechanism. #23 is an interlocking ring. #27C are flat washers. #26B are steel ball bearings. #30 is clamp going around sliding mechanism and out to sliding handle. #31 is hole to connect sliding handle. #28 is ribbed part of sliding device for air tube connection. #33G is deeper grooves for better air tube connection. #37 is air tube.

Furthermore, in FIG. 1C, you will notice the full view of the snake plunger from the outside, which looks like a regular plunger, with the exception of the (track) slot #1 9J, for sliding handle #29E. It is obvious that there is the well known rubber power plunger #36. #1 9J is a slot for sliding handle. #19JJ is sliding handle lock. #20 is cap of stationary handle. #20D is end cap to sliding handle. #29E is sliding handle. #29 is stationary handle. #31K is bolt to attach sliding handle to sliding device. #35 is connection to plunger. #36 is plunger. #32 is spacer between sliding and stationary handle.

The features that make this snake plunger different and more efficient then the other snake plungers are: it has an elongated stationary handle #29, which allows for a longer snake and it also has a built in sliding mechanism which would allow the snake to easily enter and retract No other snake plunger has this sliding device.

The operation of this snake plunger is simple, inexpensive and easy to use. The user first tries unclogging the blockage by plunging and if not successful, unlocks. or releases, the sliding handle #29E, allowing the snake to be thrusted completely around and through the bends and curves of a toilet. When the blockage is broken loose, the user simply retracts the snake by pulling the sliding handle #29E, back to it's locked position #19JJ. It should be noted that when retracting the handle #29E, the snake plunger should remain over the toilet in case a minimal amount of waste water entered the air chamber. This process does not allow water to remain up inside. movement.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An apparatus for unclogging a toilet comprising:
The sliding mechanism which contains steel ball bearings allowing for easier operation;
The unique sliding mechanism which easily allows movement of the snake within the handle;
No other plunger has this sliding mechanism, which makes this plunger unique;

2. The sliding handle which is in a locked position when the snake is not in use;

3. The rubber air tube, when plunging, does not allow water to enter;
The top end of the rubber air tube is connected to the sliding mechanism;
There is a hollow nipple inside a reducer which connects to the lower end of the rubber tube;

4. The snake goes through the nipple and up the hollow tube to the sliding mechanism;
The top end of the snake is threaded through the sliding mechanism; and
There is a locking device on the top of the sliding mechanism connected to the snake.

5. There is a reducer connecting the plunger to the stationary handle.
